(19) United States
(12) Patent Application Publication
(10) Pub. No.: US 2012/0186982 A1
(43) Pub. Date: Jul. 26, 2012

(54) MODIFIED TUNGSTEN OXIDE AND PROCESS FOR ITS PREPARATION

(75) Inventors: Laura Meda, Galliate (NO) (IT); Alessandra Tacca, Cressa (NO) (IT); Carlo Alberto Bignozzi, Ferrara (IT); Stefano Caramori, Viconovo (FE) (IT); Vito Cristino, Ferrara (IT)

(73) Assignee: ENI S.p.A, Roma (IT)

(21) Appl. No.: 13/388,139

(22) PCT Filed: Jul. 8, 2010
(86) PCT No.: PCT/EP2010/004404

§ 371 Date: Apr. 5, 2012

(30) Foreign Application Priority Data
Jul. 31, 2009 (IT) MI2009A001394

(51) Int. Cl. C01G 41/02; C25B 9/00; C25B 1/04; C25B 1/00; C25B 11/04

(52) U.S. Cl. 205/50; 205/538; 204/291; 205/340; 204/242

(57) ABSTRACT

The present invention relates to a modified tungsten oxide having an atomic concentration of 0.5 to 7.0%, preferably from 2.0 to 5.0%, of nitrogen atoms in lattice position, with respect to the total number of atoms of the oxide, having a surface morphology, detectable by means of a scanning electron microscope, characterized by nanostructures in the form of vermiform or branched open swellings, preferably having a length ranging from 200 to 2,000 nm, and a width ranging from 50 to 300 nm, having an appearance similar to Rice Krispies. The present invention also relates to a process for the preparation of the above oxide by the anodization of metallic tungsten, and also a photoanode comprising the above oxide.

The present invention relates to a modified tungsten oxide and a process for its preparation.

In the field of materials which can be used for the preparation of photoanodes, tungsten oxide (WO₃) is receiving increasing attention due to its promising photo-activity and numerous applications of the photoanodes produced with this material. The use of photoanodes of WO₃ in devices for photoanodic reactions, such as photo-electrolytic cells for the production of hydrogen from water, is particularly promising.

The effectiveness of a photoanode in the conversion of light radiations in an electric current (photocurrent) depends on various factors, among which the extension of the surface area of the photoanode exposed to the radiations and the extension of the spectral range of the absorbed photons which can be converted into electric current.

One of the known techniques of the state of the art for preparing WO₃ with a high surface area is anodic oxidation (anodization) of metal tungsten sheets in a suitable electrolytic solution. The electrolytic solution in which the anodization process is carried out is generally a mixture of one or more inorganic acids in water (for example sulfuric, oxalic, hydrofluoric acid). In the state of the art the use is known of electrolytic solutions in which, instead of water, organic solvents are used as main solvent, such as ethylene glycol, or mixtures of these with water.

The preparation of photoanodes of WO₃ by anodization of metal tungsten carried out under the above electrolytic solutions, allows photoelectrodes of metal tungsten to be obtained, having a surface consisting of WO₃ nanostructures with dimensions varying from 10 to 100 nm (nanostructured WO₃). This morphology gives the photoanodes a high specific surface of oxide which can be exposed to light radiation.

Photoanodes having WO₃ nanostructured surfaces known in the state of the art, however, have a rather limited conversion capacity of photons into photocurrents, as they are only capable of effectively converting photons having a frequency falling within the region of the ultraviolet spectrum (wavelength ranging from 10 to 380 nm).

In order to amplify the spectral region of radiation convertible to photocurrent, structurally modifying WO₃ by doping with other elements such as, for example, N, S, F and C, has been proposed.

The doping techniques used in the state of the art, however, are not capable of introducing doping elements inside the crystalline lattice of the oxide in a sufficient quantity for significantly improving its conversion capacity of the photons into photocurrents and, consequently, the photoelectrochemical activity.

An objective of the present invention is to overcome the drawbacks observed in the state of the art.

In particular, an objective of the present invention is to identify a modified tungsten oxide and a process for preparing this modified tungsten oxide, which can be used as photoanode, having an improved photoelectrochemical activity.

A first object of the present invention relates to a modified tungsten oxide having an atomic concentration of 0.5 to 7.0%, preferably from 2.0 to 5.0%, of nitrogen atoms in lattice position, with respect to the total number of atoms of the oxide, having a surface morphology, detectable by means of a scanning electron microscope, characterized by nanostructures in the form of vermiform or branched open swellings, preferably having a length ranging from 200 to 2,000 nm, and a width ranging from 50 to 300 nm, having an appearance similar to Rice Krispies.

A second object of the present invention relates to a process for preparing a modified tungsten oxide, comprising an anodization reaction (anodic oxidation) of metal tungsten, characterized in that the anodization is carried out with an electrolytic solution comprising:
(i) at least 25% by weight of a nitrogenated organic compound;
(ii) from 0.01 to 3% by weight of fluoride ions;
(iii) from 1 to 50% by weight of an oxidizing compound of metal tungsten under electrolytic conditions, preferably water.

A further object of the present invention relates to a photoanode of modified tungsten oxide according to the present invention.

The Applicant has surprisingly found that it is possible to produce modified tungsten oxide (WO₃), specifically a modified tungsten oxide containing from 0.5 to 7.0% of N atoms in lattice position, with an appearance similar to rice krispies, by the anodization of metal tungsten, preferably in the form of a lamina, in a suitable electrolytic solution.

The modified tungsten oxide according to the present invention, when used as photoanode, is capable of producing higher photocurrent density with respect to those of the WO₃ photoanodes known in the state of the art. Although there is no intention of making reference to any particular theory in the present description, the best photoelectrochemical activity is considered as being due to the particular surface morphology of the WO₃ obtained with the process object of the present invention, combined with the presence of nitrogen atoms (doping element) inserted in the crystalline lattice of the WO₃ (lattice position), i.e. inserted in the structure of the oxide in a position of the lattice normally occupied by an oxygen atom.

These structural characteristics allow the modified WO₃ to effectively convert to electric current, photons having wavelengths falling within the spectral range which, in addition to UV, also comprises a part of the visible region (up to about 470 nm).

For a better understanding of the characteristics of the present invention in the description, reference will be made to the following figures:

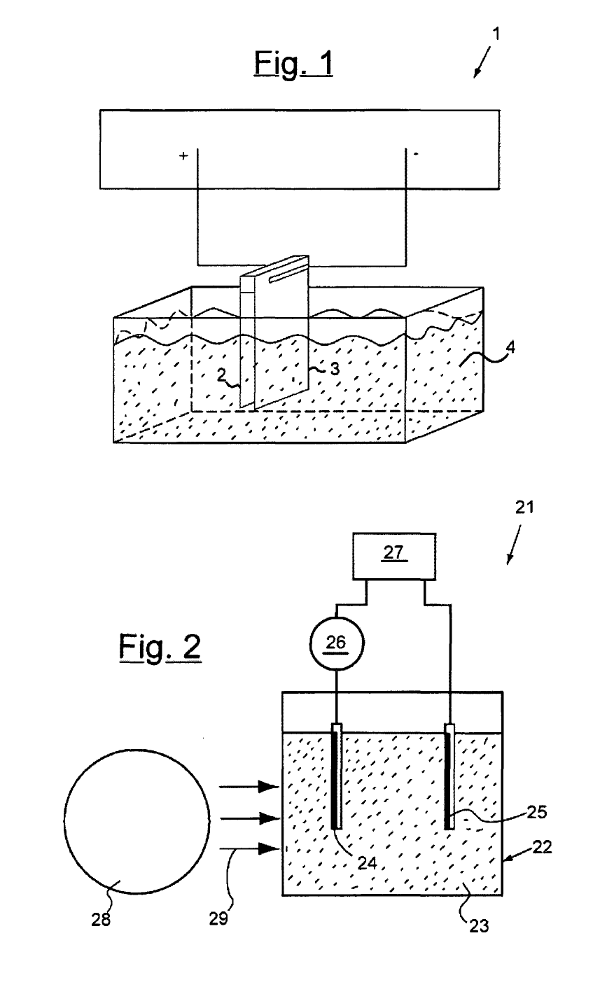

FIG. 1, schematic representation of an electro-chemical cell for the anodization of laminas of metal tungsten;

FIG. 2, schematic representation of a photoelectrolytic cell for testing the photoelectrochemical activity of WO₃ photoanode, object of the present invention;

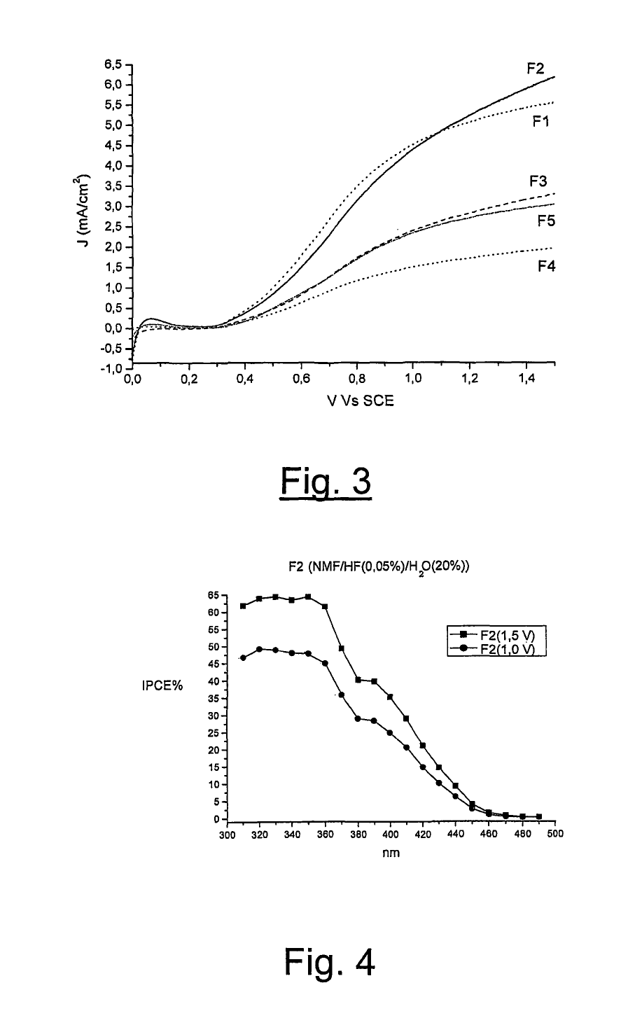

FIG. 3, J-V curve relating to five WO₃ photoanodes (samples F1-F5) prepared according to the present invention and to the state of the art;

FIG. 4 photo-action spectrum of a WO₃ photoanode (sample F2) prepared according to the present invention with different bias values;

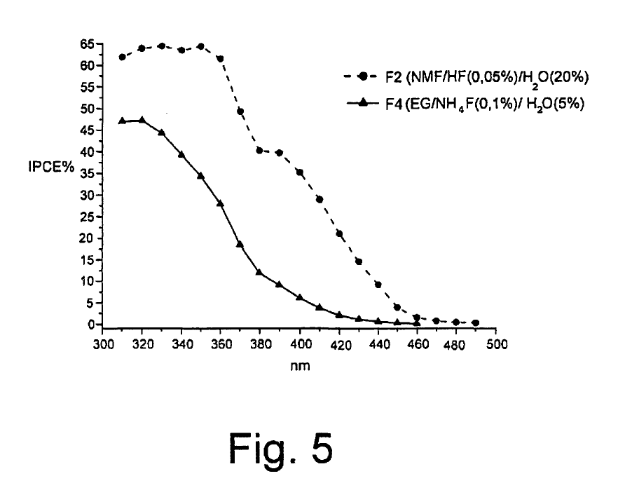

FIG. 5, photo-action spectrum of a WO₃ photoanode prepared according to the present invention (sample (F2) and a WO₃ photoanode prepared according to the state of the art (comparative sample F4);

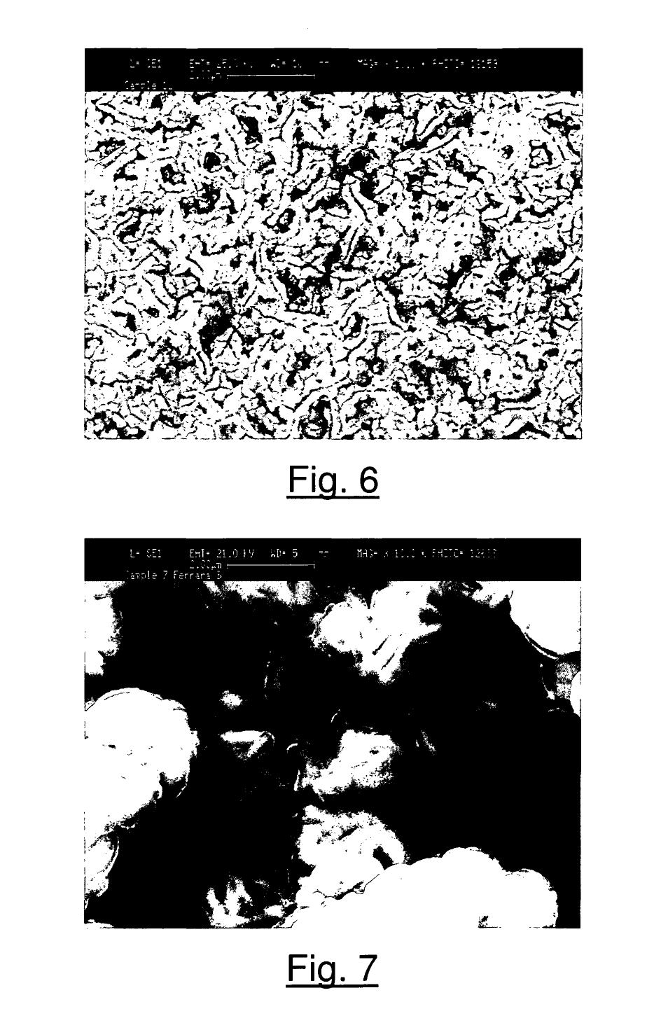

FIG. 6, image taken under a SEM scanning electron microscope (magnification: 10,000×) of a sample of tungsten oxide according to the present invention;

FIG. 7, image taken under a SEM scanning electron microscope (magnification: 10,000×) of a sample of tungsten oxide obtained by traditional anodization in water.

According to the process of the present invention and with reference to FIG. 1, in order to prepare WO₃ modified with nitrogen atoms, an electro-chemical cell is used, for example, in which the operating electrode 2 and the counter-electrode 3 are two laminas of metal W situated inside a suitable electrolytic solution 4 at a preferred distance from each other of 1 to 15 mm, more preferably from 2 to 10 mm.

The thickness of the tungsten laminas is not particularly important, but it preferably ranges from 0.5 to 5 mm. Furthermore the lamina which forms the cathode can also consist of metals different from W, provided they cannot be attacked by the electrolytic solution, for example Pt, Ni, steel or graphite.

The electrolytic solution, in addition to the components previously specified, can optionally contain up to 50% by weight, preferably from 0 to 25% by weight, of a further organic solvent, for example an alcohol having from 1 to 5 carbon atoms, an organic acid having from 1 to 5 carbon atoms, a polar aprotic organic compound having from 1 to 4 carbon atoms and at least one atom selected from oxygen or halogen, particularly O or F. Organic solvents of the above type are for example ethanol, propanol, acetic acid, ethylene glycol, tetrahydrofuran, acetone, ethyl acetate, diglyme, 3,3,3-trifluoropropanol.

The anodization process is preferably carried out maintaining the potential difference applied to the electrodes (potentiostatic anodization) constant. The potential difference applied to the electrodes ranges from 5 to 60 V, preferably from 30 to 40 V.

The anodization process is prolonged for a time ranging from 1 to 72 hours, preferably from 5 to 72 hours, more preferably from 12 to 72 hours, even more preferably from 48 to 72 hours. It has been observed that prolonging the duration of the anodization for over 72 hours does not produce improvements in the performances of the photoanodes of modified WO₃.

During the anodization, the surface of the tungsten lamina is converted to nanostructured tungsten oxide (WO₃). According to the most affirmed theory of the state of the art, the growth of the nanostructured WO₃ derives from the combination of two processes which take place during the anodization: the electrochemical formation of WO₃, by reaction of metal tungsten with the oxygen of the species present in the electrolytic solution (in particular the oxygen of water) and the dissolution of part of the WO₃ formed as a result of the fluoride ions present in the electrolytic solution. The dissolution of the oxide is assisted by the intense electric field which is established at the electrode-electrolytic solution interface by potential differences higher than 10 V.

When the process is carried out in electrolytic cells with two electrodes positioned at a distance varying from 1 to 15 mm, during the anodization, average values of current in the circuit of the electrolytic cell varying from 4 to 15 mA/cm² are observed, at temperatures ranging from 20 to 40° C., preferably from 25 to 35° C.

According to the process of the present invention, in order to prepare modified WO₃ having an improved photo-electrochemical activity, it is preferable to use an electrolytic solution comprising:
(i) from 25 to 98.09%, more preferably from 60 to 94.99%, by weight of a nitrogenated organic compound;
(ii) from 0.01 to 3% by weight of fluoride ions;
(iii) from 1 to 50% by weight of water, more preferably from 5 to 30%, even more preferably from 10 to 20%.

In addition to the above components, as already mentioned, the electrolytic solution can optionally also contain a suitable organic solvent and other possible electrolytic salts, in order to improve the conductivity, as is known to experts in the field.

Nitrogenated organic compounds (i) which are particularly suitable for the present invention are compounds comprising from 1 to 25, preferably from 1 to 10, more preferably from 1 to 5, carbon atoms, and at least one nitrogen atom. These compounds (i) are advantageously liquid at the electrolytic process temperature, they are more advantageously liquid at room temperature. Compounds of the above type are in particular organic amines and amides.

According to a particular aspect of the present invention, said nitrogenated organic compounds (i) are at least partially miscible with water, i.e. they advantageously form homogeneous mixtures of water/compound (i) comprising from 3 to 50% by weight, preferably from 10 to 50% by weight, of water.

The best results are obtained using as nitrogenated organic compound an organic amide having general formula (I)

R₁-A-NR₂R₃ (I)

wherein:
R₁ is H, or a C₁-C₆, preferably C₁-C₃, alkyl group, or an amine group —NR₂R₃;
R₂ and R₃, independently of each other, are H or a C₁-C₆, preferably C₁-C₃ alkyl group;
A is a divalent group selected from CO, SO₂, POR′, wherein R′ independently has the same meaning as R₁.

Specific examples of these compounds are formamide, N-methyl-formamide (NMF), N,N-dimethyl-formamide (DMF), methylsulfonamide, N-methylmethylsulfonamide, hexamethyl phosphoramide, urea (especially in a hydro-alcohol solution), and N,N-dimethylurea.

The electrolytic solution preferably contains, as nitrogenated organic compound, an amide having the above general formula (I) wherein A is CO, R₂ or R₃ are independently H or C₁-C₃ and R₁ has the meaning previously defined. Even more preferably, R₂ is H and R₃ is a C₁-C₃ alkyl.

More preferably, the electrolytic solution comprises, as nitrogenated organic compound, a solvent selected from the group consisting of N-methyl-formamide (NMF), N-ethylformamide, N-methylacetamide, N ethylacetamide, N,N-dimethyl-formamide (DMF). Even more preferably, the nitrogenated organic compound is NMF.

A second component of the electrolytic solution is the oxidizing compound of metal tungsten under electrolytic conditions, which can consist of any oxygen donor compound under these conditions, such as, for example, a peroxide in a concentration of 1 to 10% by weight or, preferably, water. In the preferred latter case, the water is present in the electrolytic solution in a concentration varying from 1 to 50% by weight with respect to the total weight of the electrolytic solution. More preferably, the concentration of the water is within the range of 5-30% by weight of the electrolytic solution, even more preferably within the range of 10-20% by weight.

If a different oxidizing agent is used, for example, hydrogen peroxide, this is preferably present in concentrations of 1 to 10% by weight.

In the absence of water or other oxidizing agent, the formation of the WO₃ oxide as a result of the anodization process is negligible.

For the purposes of the present invention, the electrolytic solution also comprises fluoride ions. These ions can be added to the electrolytic solution, for example, in the form of hydrofluoric acid (HF) or fluoride salts, such as for example ammonium fluoride (NH₄F), alkylammonium fluorides (such as tetraethylammonium fluoride and tetrabutylammonium fluoride), sodium fluoride (NaF), potassium fluoride (KF) and/or mixtures thereof. The fluoride salts can be optionally present in combination with HF.

The best results in terms of photoelectrochemical activity of modified WO₃ are obtained using an electrolytic solution comprising NH₄F or HF in a concentration of 0.03 to 0.5% by weight, more preferably from 0.04 to 0.10% by weight of fluoride ions.

The level of acidity or basicity of the electrolytic solution is not particularly important for the purposes of the present invention. For practical reasons, however, relating to the solubility of the salts or electrolytes present in solution, it is convenient to operate under acid conditions, with a molar concentration of hydrogen ions ranging from 10⁻⁶ to 1.

At the end of the anodization process, the lamina is extracted from the electrolytic solution and subjected to washing with deionized water and subsequently acetone. The lamina is then preferably treated in an ultrasound bath in distilled water for five minutes. This treatment allows the removal of possible material weakly bound to the surface.

After the washing treatment, the lamina is subjected to heat treatment in air (calcination) according to the usual technique, normally at a temperature ranging from 450 to 600° C., preferably from 500 to 580° C., for a time ranging from 1 to 5 hours, preferably from 2 to 4 hours.

The calcination treatment has the purpose of improving the crystallinity degree of the WO₃ oxide obtained, reducing the defects of its crystalline lattice and increasing carrier conductivity.

After the calcination treatment, a lamina of modified WO₃ is obtained, which can be used as photoanode.

The process, object of the present invention, allows WO₃ modified (doped) with nitrogen atoms, to be obtained. As can be deduced through photoelectron spectroscopy measurements (XPS), the nitrogen atoms are in fact inserted in the crystalline lattice of the WO₃. The doping of the WO₃ involves the substitution of oxygen atoms of the oxide with a quantity of nitrogen atoms which is such as to produce a concentration of bound N ranging from 0.5 to 70, preferably from 2 to 5%, with respect to the total number of atoms of the modified (doped) oxide, as can be deduced from the shift towards low energies of the UV-Visible absorption band.

It has been found that the most interesting and advantageous results are obtained when the N/W atomic ratio in the surface layer of oxide modified according to the present invention, is equal to or higher than 0.1, more preferably ranging from 0.1 to 0.3.

XPS analyses also show that the WO₃ photoanodes can have varying quantities of carbon atoms on the surface (up to 30% of the overall number of atoms present, preferably from 0 to 20%). The carbon atoms, unlike the doping nitrogen atoms, do not belong to the crystalline lattice of WO₃.

X-ray diffractometry analysis (XRD) shows that the oxide consists of a phase of monoclinic WO₃ together with a sub-stoichiometric phase of the type WO_{2.83}.

The anodization process according to the present invention generally allows modified tungsten oxide to be obtained in the form of a thin layer on the metallic surface of the tungsten electrode (usually a suitably sized lamina) subjected to anodization as described above. The morphology and atomic composition of the tungsten oxide according to the present invention therefore refer to this surface layer, examined by means of electronic microscopy and XPS analysis, whose thickness can be qualitatively estimated within a range of 100 to 1,000 nm, according to the preparation conditions.

From a structural point of view, the surface of the WO₃ modified according to the present invention has a nanostructured morphology, i.e. it consists of elongated nanostructures of WO₃ having variable dimensions, but for over 95% included within lengths of 200 to 2,000 nm, having a morphology, as previously indicated, with an appearance similar to rice krispies.

Observation of the modified WO₃ under a scanning electron microscope (SEM) (FIG. 6) does in fact show a corrugated surface in which the WO₃ is characterized by a morphology which has original oxide domains having the form of vermiform, i.e. winding, or branched swellings, with a length which can be estimated with a microscope ranging from 200 to 2,000 nm, preferably from 300 to 1,500 nm for over 95%, and a width ranging from 100 to 400 nm, which show a characteristic longitudinal groove or split, more or less branched, in the centre which is not present in the tungsten oxide obtained according to the methods of the known art (FIG. 7).

The higher photoelectrochemical activity observed for the modified WO₃ photoanodes according to the present invention is thought to depend on this structural morphology, together with the doping action of the nitrogen atoms, with respect to the WO₃ photoanodes obtained by anodization processes currently known in the art, or by other known synthesis processes, for example, the chemical sol-gel preparation of nanocrystals from colloidal systems, according to what is described in international patent applications WO99/067181 and WO07/094,019, and in the publications “C. Santato et al. J. Phys. Chem B 2001, 105, 936” and “C. Santato et al. J. Am. Chem. Soc. 2001, 123, 10639”.

In particular, the photoelectrochemical activity observed for the modified WO₃ photoanodes, object of the present invention, is higher than that of photoanodes obtained by anodic oxidation of metal tungsten laminas in electrolytic solutions based on ethylene glycol, water and NH₄F.

The photoanodes, object of the present invention, are in fact capable of conducting currents having an intensity of up to about 5 mA/cm² in the presence of a bias equal to 1 V (with respect to a saturated calomel reference electrode—SCE), under simulated solar irradiation (xenon lamp) at a power of 0.12 W/cm². This high photo-electrochemical activity is due to the capacity of the WO₃ photoanodes doped with nitrogen and having a morphology of the “Rice Krispies” type described above, of converting not only photons having a frequency falling within the spectral UV region into photocurrent, but also those having a frequency falling within the spectral visible region (up to 470 nm). The shift towards the visible region is strictly linked to the decrease in the band-gap (i.e. the difference in energy between the highest energy level of the valence band and the lowest energy level of the conduction band) of the WO₃ modified according to the present invention with respect to that of WO₃ prepared colloidally or also anodically in the absence of nitrogenated organic compounds.

WO₃ photoanodes prepared with electrolytic solutions comprising amides, in particular monoalkyl-substituted formamides, show high conversion percentages of photons to photocurrent (up to 65% of incident photons as can be seen, for example, from FIG. 5).

Chrono-coulombometric analyses carried out on the modified WO₃ photoanodes according to the present invention also show a capacity of storing approximately double the electric charge with respect to that of WO₃ photoanodes obtained according to the known techniques of the state of the art, in particular with respect to those prepared by deposition of colloidal nanocrystalline films. From chrono-coulombometric data, in fact, it can be observed that in the photoanodes, object of the present invention, the active surface accessible to the solvent of the electrolytic solution and therefore exploitable for the production of photocurrents, is about double with respect to that of photoanodes based on the deposition of a colloidal nanocrystalline film.

The properties of the modified tungsten oxide, object of the present invention, make the photoanodes produced with this oxide particularly suitable for applications based on photoanodic reactions.

A further object of the present invention therefore relates to a photoelectrolytic cell comprising a modified WO₃ photoanode according to the present invention.

Another object of the present invention also relates to a photoanodic process effected with the use of a modified WO₃ photoanode according to the present invention.

In particular, a further object of the present invention relates to a photo-production process of hydrogen from water (photo-splitting) carried out using a modified WO₃ photoanode according to the present invention. In this type of process, the use of the WO₃ photoanodes described above is particularly advantageous, as the production of hydrogen is directly proportional to the photocurrent generated by the photoanode due to solar illumination.

The following embodiment examples are provided for purely illustrative purposes of the present invention and should not be considered as limiting the protection scope defined by the enclosed claims.

### EXAMPLE 1

### Preparation of the Photoanode “F1” (NMF/NH₄F (0.05%)/H₂O (20%))

A WO₃ photoanode was prepared starting from a lamina of metal W having a thickness of 0.5 mm and an area of 1 cm² by means of the potentiostatic anodic oxidation process, object of the present invention.

An apparatus of the type schematically represented in FIG. 1 was used for the anodization.

The anodization was carried out in an electrolytic solution having the following weight percentage composition:
20% H₂O;
0.05% NH₄F;
NMF for the remaining weight percentage.

A potential difference of 30 V was applied to the electrodes for 72 consecutive hours.

At the end, the lamina was subjected to washing with deionized water and acetone and subsequently positioned in an ultrasound bath of distilled water for five minutes.

The lamina was then calcined in air at 550° C. for 1 h.

### EXAMPLE 2

### Preparation of the Photoanode “F2” (NMF/HF (0.05%)/H₂O (20%))

A second modified WO₃ photoanode was prepared with the same equipment described in Example 1.

The anodization was carried out in an electrolytic solution having the following weight percentage composition:
20% H₂O;
0.05% HF;
NMF for the remaining weight percentage.

A potential difference of 40 V was applied to the electrodes for 72 consecutive hours.

The washing and calcination of the lamina were effected as described in Example 1.

### EXAMPLE 3

### Preparation of the Photoanode “F3” (DMF/NH₄F (0.1%)/H₂O (20%))

A third modified WO₃ photoanode was prepared with the same equipment described in Example 1.

The anodization was carried out in an electrolytic solution having the following weight percentage composition:
20% H₂O;
0.1% NH₄F;
DMF for the remaining weight percentage.

A potential difference of 40 V was applied to the electrodes for 72 consecutive hours.

The washing and calcination of the lamina were effected as described in Example 1.

### EXAMPLE 4 (COMPARATIVE)

### Preparation of the Photoanode “F4” (EG/NH₄F (0.1%)/H₂O (5%))

A fourth modified WO₃ photoanode was prepared with the same equipment described in Example 1.

The anodization was carried out in an electrolytic solution having the following weight percentage composition:
5% H₂O;
0.1% NH₄F;
ethylene glycol (EG) for the remaining weight percentage.

A potential difference of 40 V was applied to the electrodes for 72 consecutive hours.

The washing and calcination of the lamina were effected as described in Example 1.

### EXAMPLE 5 (COMPARATIVE)

### Preparation of the Photoanode “F5”—Anodization in Water

A fifth WO₃ photoanode was prepared by deposition of a nanocrystalline film according to the process described in the work (Y. Guo et al. Environm. Sci. And Technol. 2007, 41, 4422). In accordance with this, the anodization was carried out with the same equipment described in Example 1, containing an electrolytic solution having the following weight percentage composition:
0.3% HF;
0.2% NH₄F;
99.5% H₂O;

A potential difference of 60 V was applied to the electrodes for 48 consecutive hours.

The washing and calcination of the lamina were effected as described in Example 1.

XPS Spectroscopy

The characterization by means of XPS spectroscopy of the WO₃ photoanodes was effected with a Physical Electronics (mod. PHI-5500) spectrometer, with a monochromatized aluminium source for X-ray generation (energy of the X-rays irradiating the sample=1486.6 eV). The technique is based on the photoelectric effect, whereby the photo-electrons emitted from the surface of the irradiated sample are obtained and analyzed. The analyses are effected in an ultra-high-vacuum environment (UHV=1.32·10-7 Pa) at room temperature. In order to compensate the positive charge, which is produced on the surface after the photo-emission process, the sample is struck with a beam of low-energy electrons (neutralizer). The analysis area is circular with a diameter of about 0.4 mm and the depth of the sampling is 10 nm approximately. This is a surface analysis, capable of revealing the presence of surface closest chemical species.

A quantitative response is obtained from the XPS spectrum, relating to the atomic percentage of the most abundant elements, excluding hydrogen.

Single components of a particular chemical element with different electronic neighbourhood can also be obtained from the relevant spectra acquired in high resolution. In this case, the peak corresponding to the orbital W 4f 7/2″ served as internal energy reference, to define an absolute position on the scale of the abscissa, establishing its maximum being at 36.0 eV. Other peaks, after energy correction, can be separated into their components, attributable to species with a different surrounding. The XPS spectrum is expressed in terms of “Binding Energy” (B.E.), i.e. the energy necessary for removing a surface electron. The form of each peak provides further information (FWHM) and its area is proportional to the relative concentration of the chemical element in the analyzed layer. A more detailed description of the XPS spectroscopy technique and its use in surface analysis is described, for example, in the publication: J. F. Moulder, W. F. Stickle, P. E. Sobol, K. D. Bomben, Handbook of X-Ray Photoelectron Spectroscopy; ed. J. Chastain, Physical Electronics Div., Eden Prairie, Mo. USA (1992).

The results of the XPS analyses in terms of atomic composition (at %) of samples F1, F3, F4, F5 are indicated in Table 1.

TABLE 1

| | W | O | N | C | N/W |
|---|---|---|---|---|---|
| Sample | (at %)^{a} | (at %)^{a} | (at %)^{a} | (at %)^{a} | (at/at) |
| F1—NMF | 22.8 | 57.1 | 5.0 | 15.1 | 0.219 |
| F3—DMF | 21.9 | 44.5 | 2.3 | 31.3 | 0.105 |
| F4—EG | 19.2 | 39.3 | 1.7 | 39.8 | 0.089 |
| F5—H₂O | 20.9 | 46.2 | 1.9 | 31.0 | 0.091 |

^{a}percentage concentration of atoms of the element with respect to the total number of atoms present.

XPS analysis showed that nitrogen atoms were inserted in the crystalline lattice of the WO₃ in varying concentrations with the electrolytic bath, as demonstrated by the broadening of the absorption band up to 470 nm. Nitrogen is in fact present in all the cases as contaminant, but it is more abundant on the surface of samples F1 and F3. Carbon atoms, on the other hand, are external contaminants positioned outside the lattice.

Photoelectrochemical Activity

The photoelectrochemical activity of samples F1-F5 was determined in a photoelectrochemical cell of the type schematically represented in FIG. 2.

The photoelectrochemical cell 21 consists of a basin 22, preferably made of quartz, which contains an electrolytic solution 23 consisting of water and sulfuric acid in such a quantity as to have a pH=0.

The photocurrent measurements can be effected either with two electrodes (photoanode 24 and cathode 25), as represented in FIG. 2, or with three electrodes (photoanode—cathode—reference). A voltage generator (27) capable of providing the electrodes with the desired voltage with an increase rate of 10-20 mV/s, is connected externally between the anode and cathode. A current meter (ammeter 26), positioned in series with the generator, registers the electric current which flows externally between the two electrodes.

The whole circuit is closed in the electrolytic solution 23 with the current of positive ions which migrate from the anode 24 to the cathode 25 in the opposite direction to the flow of electrons in the external circuit. The cathode 25 consists of a commercial platinum screen with a high surface, connected to the voltage generator 27. The photoanode 24, also connected to the generator 27 and ammeter 26, consists of a metal tungsten lamina having both surfaces composed of modified WO₃ obtained according to the previous examples 1 to 5. The photoanode 24 is illuminated by a polychromatic xenon lamp 28 which simulates solar radiation (irradiation equal to 0.12 W/cm²; filter AM 1.5).

The photocurrent produced by the photoanode 24 due to the incident radiation 29 is measured with an increase in the voltage applied to the electrodes (J-V curve). The voltage applied to the electrodes is measured with respect to a saturated calomel reference electrode (not shown in FIG. 2). The cell 21 is also provided with suitable devices for collecting the gaseous oxygen which is developed at the anode and the gaseous hydrogen which is developed at the cathode during the photoreaction.

FIG. 3 shows the J-V curve relating to the electrodes obtained according to examples 1 (F1), 2 (F2), 3 (F3), 4 (F4) and 5 (F5). In the case of the sample F1 (NMF/NH₄F (0.05%)/H₂O (20%)), the curve indicates the attainment of currents of about 5 mA/cm² in correspondence with a bias equal to about 1.0 V towards SCE. On the sample F4 (EG/NH₄F (0.1%)/H₂O (5%)) (COMPARATIVE) the intensity of the photocurrent is lower than 2.0 mA/cm² for bias values up to 1.5 V towards SCE (last section of the curve not shown in FIG. 1). The J-V curves of FIG. 3 therefore show the advantageous and unexpected effect of the use of electrolytic solutions containing nitrogenated organic solvents. The conversion efficiency of the photons in photocurrent (IPCE) of samples F2 and F4 was determined by varying the wavelength of the incident radiation, by means of a monochromator, and measuring the maximum currents obtainable. The IPCE value, or quantic efficiency value, is obtained according to the following relation:

IPCE(λ)=K[J(λ)/λP]×100

wherein: K=constant depending on the measurement units, J(A)=photocurrent density, λ=wavelength of the incident radiation, P=power density of the incident radiation.

A 100% IPCE corresponds to the generation of an electron for each incident photon.

FIG. 4 shows the photo-action spectrum of sample F2 (NMF/HF (0.05%)/H₂O (20%)). The graph indicates the IPCE % values in relation to the wavelength of the incident radiation on the surface of the photoanode F2, at two different bias values (1.0 and 1.5 V). The sample F2 showed a maximum conversion value equal to 65% of the incident photons at a wavelength of about 350 nm.

The conversion of the photons in photocurrent for the photoanode F2 is significant up to wavelength values of about 470 nm (spectral visible region).

The performances of sample F2 are much higher than those of sample F4 (EG/NH₄F (0.1%)/H2O (5%)) (COMPARATIVE), as can be observed from an analysis of the photo-action spectrum of FIG. 5. In particular, it can be noted that sample F4 has a quantic efficiency generally lower than that of sample F2 for the whole width of the spectrum examined and, in addition, it does not produce significant quantic conversion efficiencies when the wavelength of the radiation is greater than 380 nm, whereas sample F2 maintains an IPCE higher than 15% in the portion of visible spectrum ranging from 380 to 430 nm.

### Scanning Electron Microscope Analysis (SEM)

The SEM analysis was carried out with a scanning electron microscope with a field emission (FE-SEM) model JEOL JSM 7600F.

FIGS. 6-7 show the photographs obtained with SEM for samples F1 and F5 respectively. The photographs show the presence of a surface consisting of WO₃ particles having a morphology similar to that of Rice Krispies, with characteristic vermiform or branched swellings having an opening in central position extending longitudinally for the whole length of the swelling.

1) Modified tungsten oxide having an atomic concentration of from 0.5 to 7.00, preferably from 2.0 to 5.0%, of nitrogen atoms in a lattice position, with respect to the total number of atoms of the oxide, having a surface morphology, detectable by means of a scanning electron microscope, characterized by a nanostructure in the form of vermiform or branched open swellings, preferably having a length ranging from 200 to 2,000 nm, and a width ranging from 50 to 300 nm.

2) The modified tungsten oxide according to claim 1, wherein said nanostructure comprises tungsten oxide domains shaped as winding or branched open swellings having a longitudinal groove.

3) The modified tungsten oxide according to either claim 1 or 2, characterized in that it has an N/W atomic ratio equal to or higher than 0.1, more preferably ranging from 0.1 to 0.3.

4) A process for preparing a modified tungsten oxide according to claim 1, comprising an anodization reaction of metallic tungsten, characterized in that the anodization is carried out with an electrolytic solution comprising:
(i) at least 25% by weight of a nitrogenated organic compound;
(ii) from 0.01 to 3% by weight of fluoride ions;
(iii) from 1 to 50% by weight of an oxidizing compound of metallic tungsten under electrolytic conditions, preferably water.

5) The process according to claim 4, wherein the electrolytic solution also comprises up to 50% by weight, preferably from 0 to 25% by weight, of an organic solvent, selected from the group consisting of an alcohol having from 1 to 5 carbon atoms, an organic acid having from 1 to 5 carbon atoms, a polar aprotic organic compound having from 1 to 4 carbon atoms and at least one atom selected from oxygen or halogen, particularly O or F.

6) The process according to claim 4 or 5, wherein the nitrogenated organic compound is a compound comprising from 1 to 25, preferably from 1 to 10, carbon atoms, and at least one nitrogen atom, preferably an organic amine or an organic amide.

7) The process according to any of the previous claims from 3 to 5, wherein the nitrogenated organic compound is an organic amide having general formula (I)
R₁-A-NR₂R₃ (I)
wherein
R₁ is H, or a C₁-C₆, preferably C₁-C₃, alkyl group, or a —NR₂R₃ amine group;
R₂ and R₃, independently of each other, are H or a C₁-C₆, preferably C₁-C₃, alkyl group;
A is a divalent group selected from CO, SO₂, POR′, wherein R′ independently has the same meaning as R₁.

8) The process according to claim 7, wherein the nitrogenated organic compound is an amide having general formula (I) wherein A is CO, R₂ or R₃ are independently H or C₁-C₃ and R₁ has the meaning previously defined, preferably R₂ is H and R₃ is a C₁-C₃ alkyl.

9) The process according to one or more of the claims from 4 to 8, wherein the nitrogenated organic compound is selected from those capable of forming homogeneous mixtures with water comprising from 3 to 50% by weight, preferably from 10 to 50% by weight, of water, the remaining percentage consisting of said nitrogenated organic compound.

10) The process according to one or more of the claims from 4 to 9, wherein the oxidizing compound of metallic tungsten under electrolytic conditions is water in a concentration varying from 1 to 50% by weight with respect to the total weight of the electrolytic solution, more preferably from 5 to 30% by weight, even more preferably from 10 to 20% by weight.

11) The process according to one or more of the claims from 4 to 10, wherein the oxidizing compound of metallic tungsten under electrolytic conditions is a peroxide in a concentration varying from 1 to 10% by weight with respect to the total weight of the electrolytic solution, preferably hydrogen peroxide.

12) The process according to one or more of the claims from 4 to 11, wherein the electrolytic solution comprises hydrofluoric acid (HF) and/or ammonium fluoride (NH₄F) and/or tetraalkylammonium fluorides, and/or sodium fluoride (NaF) and/or potassium fluoride (KF) and/or mixtures thereof.

13) The process according to one or more of the claims from 4 to 12, wherein the electrolytic solution comprises NH₄F or HF in a concentration ranging from 0.03 to 0.5% by weight, more preferably from 0.04 to 0.10% by weight of fluoride ions.

14) The process according to one or more of the claims from 4 to 13, wherein the electrolytic solution has the following weight percentage composition:
20% H₂O
0.05% NH₄F
the remaining weight percentage being NMF.

15) The process according to one or more of the claims from 4 to 14, wherein the anodization is effected by applying a potential difference to the electrodes ranging from 5 to 60 V, preferably from 30 to 40 V.

16) The process according to one or more of the claims from 4 to 14, wherein the anodization is carried out for a time ranging from 1 to 72 hours, preferably from 5 to 72 hours, more preferably from 12 to 72 hours.

17) A photoanode comprising a modified tungsten oxide according to any claim from 1 to 3.

18) A photo-electrolitic cell comprising a photoanode according to claim 17.

19) A photoanodic process effected using a photoanode according to claim 17.

20) A photo-production process of hydrogen from water effected by using a photoanode according to claim 17.
